(19) United States
(12) Patent Application Publication
(10) Pub. No.: US 2013/0325251 A1
(43) Pub. Date: Dec. 5, 2013

(54) DEVICE AND METHOD FOR CALIBRATION OF AN ACCELERATION SENSOR

(71) Applicant: Erik Öhlund, Jarna (SE)

(72) Inventor: Erik Öhlund, Jarna (SE)

(21) Appl. No.: 13/979,785

(22) PCT Filed: Jan. 25, 2012
(86) PCT No.: PCT/SE2012/050070

§ 371 Date: Aug. 20, 2013

(30) Foreign Application Priority Data
Feb. 8, 2011 (SE) 1150091-5

(51) Int. Cl. G01P 15/00

(52) U.S. Cl. CPC G01P 15/00
USPC 701/33.1

(57) ABSTRACT

A method for calibration of an acceleration sensor (220) to determine acceleration indications of a motor vehicle (100, 110): Determine a characteristic constant (α0) for the acceleration sensor (220) at the time of refuelling the vehicle. A computer program product contains program code (P) for a computer (200; 210; 400) for implementing the method. Also a device and a motor vehicle (100) which is equipped with the device.

### TECHNICAL FIELD

The present invention relates to a method for calibration of an acceleration sensor in order to determine acceleration indications of a motor vehicle. The invention relates also to a computer programme containing programme code for a computer for implementing a method according to the invention. The invention relates also to a device for calibration of an acceleration sensor in order to determine acceleration indications of a motor vehicle, and to a motor vehicle which is equipped with the device.

### BACKGROUND

In vehicles today, accelerometers are used to determine their acceleration indications which may themselves be used to determine prevailing movement resistances for said vehicles. An accelerometer may also be referred to as an acceleration sensor. These accelerometers currently work satisfactorily. Accelerometers are well known and are often physically connected to an ECU (electronic control unit) of the vehicle in order to send information signals containing acceleration indications for the vehicle to said ECU. Said ECU is adapted to determining a slope of a running surface for the vehicle, e.g. a road gradient, on the basis of said acceleration indications. The slope of the running surface thus determined may be used to calculate a prevailing running resistance for the vehicle. This calculated running resistance may then be used as input data to an automatic gear choice system of the vehicle.

It is of course desirable that the calculated running resistance be determined as accurately as possible, not least to make possible an optimised automatic gearchange system for the vehicle. There are various ways of determining the vehicle's running resistance. A commonly used model comprises inter alia a term which is based on the running surface slope determined. In this context it is important that the accelerometer is correctly calibrated to minimise risk of consequent errors in the calculations which are performed for determining the running resistance.

A version of the accelerometer's sensor equation is

αₛ=αᵥ+g sin α+α₀ (1)

in which
αₛ is the value measured by the accelerometer,
αᵥ is the vehicle's acceleration, e.g. as measured by speed sensors associated with its wheels,
g is the general gravitational constant,
a is the slope of the vehicle's running surface,
α₀ is a constant also referred to as the sensor's zero level.

A force equation usable in vehicle control units is

Fₜ−Fₐᵢᵣ−Fᵣₒₗₗ−g sin α=mαᵥ (2)

in which
Fₜ is the vehicle's driving force, i.e. the force from a power train of the vehicle which act upon its wheels,
Fₐᵢᵣ is the vehicle's air resistance as determined by means of a calculation model,
Fᵣₒₗₗ is the vehicle's rolling resistance as determined by means of a calculation model.

A model of the vehicle's running resistance is F_{driveres} is

F_{driveras}=Fₜ−mαᵥ (3)

Like many different types of sensors, accelerometers are affected by external and internal factors. This means that the value of α₀ may change over time.

A possible example of such a factor is sensor drift. It is therefore extremely important to know α₀ continuously so that the slope a of the running surface can be determined with as little uncertainty as possible.

There are various ways of determining the accelerometer's zero level α₀.

JP 7301641 describes a method for calibrating an accelerometer of a vehicle. The method comprises detecting that the vehicle is stationary. If the running surface is also found to be substantially level, the accelerometer's zero level is compensated.

JP 2009264794 describes a method for calibrating an accelerometer, which is done by comparing output data from the accelerometer at the same location, e.g. a parking place, but at different times.

US 2008140292 and US 2007208524 describe methods for calibrating an accelerometer in a moving vehicle.

DE 4108081 describes a method for calibrating an accelerometer when the vehicle is sloping

### SUMMARY OF THE INVENTION

An object of the present invention is to propose a novel and advantageous method for calibrating an accelerometer of a motor vehicle.

Another object of the invention is to propose a novel and advantageous device and a novel and advantageous computer programme for calibrating an accelerometer of a motor vehicle.

A further object of the invention is to a propose a method, a device and a computer programme for effecting automated calibration of an accelerometer of a vehicle in a situation where said calibration takes place in virtually optimum conditions.

A further object of the invention is to propose a method, a device and a computer programme for making it possible to determine running resistances more accurately for an automatic gearchange system of a vehicle.

A further object of the invention is to propose a method, a device and a computer programme for achieving an improved automatic gearchange system of a vehicle.

Another further object of the invention is to achieve improved performance of a motor vehicle with an automatic gearchange system.

These objects are achieved with a method according to claim 1 for calibration of an acceleration sensor in order to determine acceleration indications of a motor vehicle.

An aspect of the invention proposes, for calibration of an acceleration sensor in order to determine acceleration indications of a motor vehicle, a method which comprises the step of determining for said acceleration sensor a characteristic constant which is determined at the time of refuelling the vehicle.

An aspect of the invention supposes that the running surface at a refuelling station is substantially level, i.e. oriented horizontally. As it is possible according to the invention to establish that the vehicle is being or has been refuelled, the accelerometer may in this context be calibrated by determining the characteristic constant for said acceleration sensor.

An aspect of the invention provides a robust method for calibrating an acceleration sensor in order to determine acceleration indications of a motor vehicle. A fuel volume meter associated with a fuel tank of the vehicle may be used to establish whether the vehicle has been refuelled. This makes it possible for said acceleration sensor's characteristic constant to be determined by direct measurement by the acceleration sensor.

The method may further comprise the step of providing an indication of said refuelling when the amount of fuel supplied exceeds a predetermined value. Said indication may be used to activate calibration of the acceleration sensor. The result is a robust way of determining said acceleration sensor's characteristic constant. Said predetermined value for the amount of fuel supplied may be any desired value, e.g. 200 or 300 litres. According to an example, said predetermined value for the amount of fuel supplied corresponds to a volume which represents 40-70 percent of the fuel tank's total volume. If the fuel tank's total volume is for example 600 litres, said predetermined value may therefore correspond to 240-420 litres. According to an example, said predetermined value for the amount of fuel supplied corresponds to a volume which represents more than 70 percent of the fuel tank's total volume, e.g. 80 percent. According to an example, said predetermined value for the amount of fuel supplied corresponds to a value which represents less than 40 percent of the fuel tank's total volume, e.g. 20 percent.

An advantage of not having too low a predetermined value for the amount of fuel supplied is that incorrect calibration of the acceleration sensor can be avoided in a situation where a small amount of fuel is supplied to the tank, e.g. in an emergency situation involving use of reserve fuel. In the case of refuelling which does not take place at a fuel station, it is certainly more hazardous to suppose that the running surface is level and therefore appropriate for effecting the desired determination of said characteristic constant.

An advantage of not having too high a predetermined value for the amount of fuel supplied is that the innovative method is not activated if it cannot be established that refuelling is taking place/has taken place. If the predetermined value is set too high, e.g. over 80 percent, determination of said characteristic constant is not effected unless refuelling is initiated when the tank is substantially empty and is replenished until it is substantially full.

The method may further comprise the step of determining said constant during refuelling. This affords the advantage that the innovative method can be activated and completed without having to switch the vehicle off. Determining said constant during refuelling results in a more versatile method in that an engine of the vehicle may be kept running during refuelling. This means that determining said constant can be done more quickly than when the engine has to be started before such determination.

According to a version, the method may comprise the step of determining said constant substantially immediately after completion of refuelling. This affords the advantage that the innovative method can be activated and completed without having to switch the vehicle off. Determining said constant immediately after completion of refuelling results in a more versatile method in that an engine of the vehicle may be kept running during refuelling. This means that determining said constant can be done more quickly than when the engine has to be started before such determination.

The method may further comprise the step of determining said constant at the time of starting the engine after refuelling. This affords the advantage of being able to refuel more safely, since it is normal to switch the engine off during refuelling. It also affords the advantage that a number of subsystems of the vehicle can be switched off during refuelling, with consequent energy savings as compared with having them in operation and using electric current.

An advantage of determining said characteristic constant during refuelling, immediately after completion of refuelling or at the time of starting the engine after refuelling is that the accelerometer can be calibrated before the vehicle moves off. This results in greater scope for so calculating the vehicle's running resistance that a substantially optimum gear choice can be calculated for an automatic gearchange system of the vehicle.

The method may further comprises the step of determining said constant at a predetermined time after the engine has been started after refuelling. Said characteristic constant need not necessarily be determined during refuelling or at the time of starting the engine, it may in appropriate circumstances be determined with a certain delay. This results in a more versatile method.

The method may comprise the step of providing said constant α₀ determined for an automatic gearchange system. The gearchange system may be an automated transmission system comprising inter alia a gearbox. Equations 1, 2 and 3 above may be used to calculate the running resistance F_{driveres} on the basis of said constant α₀ determined. The running resistance F_{driveres} is a parameter of an automatic gearchange system of the vehicle 100. Where the accelerometer is calibrated, i.e. where said constant determined α₀ is arrived at according to an aspect of the invention, a more accurate value for the running resistance F_{driveres} can be calculated. This makes it possible for the vehicle's automatic gearchange system to be controlled in a more optimum way as compared with the accelerometer not being calibrated. Determining said constant α₀ makes it possible according to the invention to achieve greater accuracy in calculations of the running resistance F_{driveres}.

According to an aspect of the invention, said constant determined may be used to determine a slope of the running surface for the vehicle. Said slope may then be used to determine a running resistance for the vehicle.

According to an embodiment, the method may comprise the step of determining said slope on the basis of said constant determined. Equation 1 above may be used to solve the road gradient a (the slope of the vehicle's running surface), since the other terms (αₛ, αᵥ, g and α₀) are known. This means that sensors with which the vehicle is already provided may be used to robustly determine the road gradient when the vehicle is being set in motion or is already on the move.

An aspect of the invention proposes a method for determining a running resistance for a vehicle provided with an acceleration sensor, comprising the steps of
determining a characteristic constant for said acceleration sensor,
determining said constant at the time of refuelling the vehicle,
determining a slope of the running surface for said vehicle on the basis of said constant determined, and
determining said running resistance for the vehicle on the basis of said slope determined.

The method may comprise the step of determining said constant when certain predetermined conditions obtain. Carrying out a check on certain predetermined conditions may provide assurance that the vehicle actually is stationary on a level running surface.

Such a check may be based on a calculated value for the slope a of the running surface. If a is small or substantially zero (0), the innovative method may be initiated, i.e. said constant α₀ may be determined in an established refuelling state. This means that the term gsin α in equation 1 above can be taken as zero (0).

Such a check may be based on a measured value for the vehicle's prevailing speed. If this value is small or substantially zero (0), the innovative method may be initiated, i.e. said constant α₀ may be determined in an established refuelling state. This means that the term αᵥ in equation 1 above may be taken as zero (0).

Said acceleration indications may be based on the vehicle's acceleration αᵥ In conjunction with the slope α of the running surface in the vehicle's longitudinal direction and/or said acceleration sensor's characteristic constant α₀ may be referred to the acceleration sensor's acceleration indication.

According to a version, adaptation of said constant α₀ may be done by means of the algorithm

n(k)=n(k−1)+(s(k)−n(k−1))β (4)

in which
n(k) is the new zero level
s(k) is the zero level read by the accelerometer, n(k−1) is the old zero level and β is an adaptation factor between 0 and 1, e.g. 0.1.

The method is easy to implement in existing motor vehicles. Software for calibration of an acceleration sensor in order to determine acceleration indications of a motor vehicle according to the invention may be installed in a control unit of the vehicle during the manufacture of the vehicle. A purchaser of the vehicle may thus have the possibility of selecting the function of the method as an option. Alternatively, software which contains programme code for applying the innovative method for calibration of an acceleration sensor in order to determine acceleration indications of a motor vehicle may be installed in a control unit of the vehicle on the occasion of upgrading at a service station, in which case the software may be loaded into a memory in the control unit. Implementing the innovative method is therefore cost-effective, particularly as no further components or sensors need be installed in the vehicle according to an aspect of the invention. Relevant hardware is currently already provided in the vehicle. The invention therefore represents a cost-effective solution to the problems indicated above.

Software containing programme code for calibration of an acceleration sensor in order to determine acceleration indications of a motor vehicle is easy to update or replace. Various parts of the software containing programme code for calibration of an acceleration sensor in order to determine acceleration indications of a motor vehicle may also be replaced independently of one another. This modular configuration is advantageous from a maintenance perspective.

An aspect of the invention proposes, for calibration of an acceleration sensor in order to determine acceleration indications of a motor vehicle, a device adapted to determining a characteristic constant for said acceleration sensor. Said device comprises means for determining said constant at the time of refuelling the vehicle.

The device may further comprise means for providing an indication of said refuelling when the amount of fuel supplied exceeds a predetermined value.

The device may further comprise means for determining said constant during refuelling or substantially immediately after completion of refuelling.

The device may further comprise means for determining said constant at the time of starting the engine after refuelling or at a predetermined time after the engine has been started after refuelling.

The device may comprise means for providing said constant determined for an automatic gearchange system.

According to an aspect of the invention, said constant determined may be used for determining a slope of the running surface for the vehicle. Said slope may then be used for determining a running resistance for the vehicle. According to an embodiment, the device may comprise means for determining said slope on the basis of said constant determined.

An aspect of the invention proposes a method for determining a running resistance for a vehicle provided with an acceleration sensor, comprising
means for determining a characteristic constant for said acceleration sensor,
means for determining said constant at the time of refuelling the vehicle,
means for determining a slope of the running surface for said vehicle on the basis of said constant determined, and
means for determining said running resistance for the vehicle on the basis of said slope determined.

The device may comprise means for determining said constant when certain predetermined conditions obtain.

Said acceleration indications are based on the vehicle's acceleration in conjunction with the running surface slope in the vehicle's longitudinal direction and/or said acceleration sensor's characteristic constant α₀ is referred to the acceleration sensor's acceleration indication.

The above objects are also achieved with a motor vehicle which is provided with the device for calibration of an acceleration sensor in order to determine acceleration indications of a motor vehicle. The vehicle may be a truck, bus or passenger car.

An aspect of the invention proposes, for calibration of an acceleration sensor in order to determine acceleration indications of a motor vehicle, a computer programme which contains programme code for causing an electronic control unit or another computer connected to the electronic control unit to perform steps according to any of claims 1-7.

An aspect of the invention proposes, for calibration of an acceleration sensor in order to determine acceleration indications of a motor vehicle, a computer programme which contains programme code stored on a computer-readable medium for causing an electronic control unit or another computer connected to the electronic control unit to perform steps according to any of claims 1-7.

An aspect of the invention proposes a computer programme product containing a programme code stored on a computer-readable medium for performing method steps according to any of claims 1-7 when said programme is run on an electronic control unit or another computer connected to the electronic control unit.

Further objects, advantages and novel features of the present invention will become apparent to one skilled in the art from the following details, and also by putting the invention into practice. Whereas the invention is described below, it should be noted that it is not restricted to the specific details described. Specialists having access to the teachings herein will recognise further applications, modifications and incorporations within other fields, which are within the scope of the invention.

### BRIEF DESCRIPTION OF THE DRAWINGS

For fuller understanding of the present invention and further objects and advantages of it, the detailed description set out below should be read together with the accompanying drawings, in which the same reference notations denote similar items in the various diagrams, and in which:

FIG. 1 illustrates schematically a vehicle according to an embodiment of the invention;

FIG. 2 illustrates schematically a subsystem for the vehicle depicted in FIG. 1, according to an embodiment of the invention;

FIG. 3a is a schematic flowchart of a method according to an embodiment of the invention;

FIG. 3b is a more detailed schematic flowchart of a method according to an embodiment of the invention; and

FIG. 4 illustrates schematically a computer according to an embodiment of the invention.

### DETAILED DESCRIPTION OF THE DRAWINGS

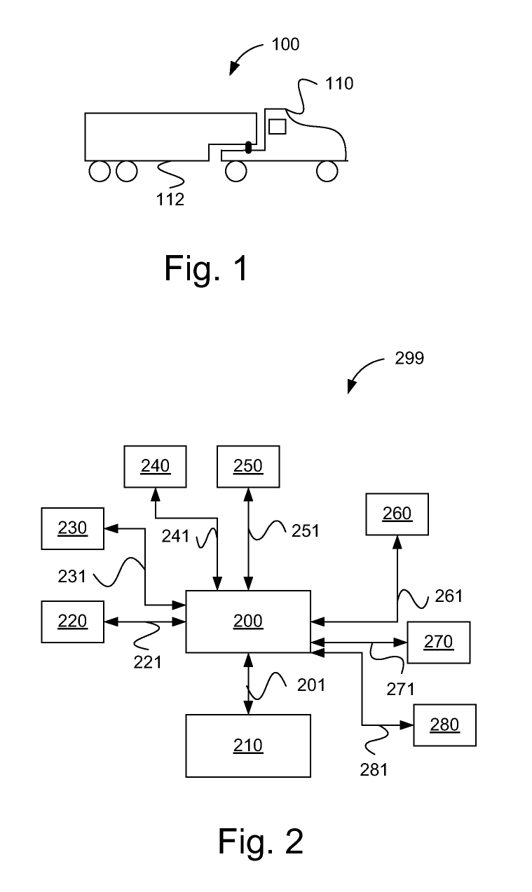

FIG. 1 depicts a side view of a vehicle 100. The exemplified vehicle 100 comprises a tractor unit 110 and a trailer 112. The vehicle may be a heavy vehicle, e.g. a truck or a bus. The vehicle may alternatively be a car.

The term “link” refers herein to a communication link which may be a physical connection such as an opto-electronic communication line, or a non-physical connection such as a wireless connection, e.g. a radio link or microwave link.

The term “fuel station” refers herein to an installation where the vehicle 100 can refuel. An example of a fuel station is a so-called filling station where vehicles can refuel with, for example, diesel fuel, petrol, ethanol, rapeseed oil, rape methyl ester or some other suitable organic, semi-synthetic or synthetic propellant.

An aspect of the invention may be applied on a vehicle which is powered by vehicle gas. This means that gas pressure in a fuel tank of said vehicle may be used to calibrate said accelerometer. This makes it possible to establish whether refuelling of the vehicle has taken place, e.g. by comparing at two different times the pressure of the gas in the fuel tank, which indicates the amount of fuel in a similar way to the case of a vehicle which is powered by, for example, diesel fuel.

An aspect of the invention may be applied on a hybrid vehicle powered by electric current. In this case the charge level of a battery of said vehicle may be used to calibrate said accelerometer. This makes it possible to establish whether charging of at least one battery of the hybrid vehicle has taken place by comparing at two different times the charge level of said battery, which indicates the electric power available in a similar way to the case of a vehicle powered by, for example, diesel fuel.

FIG. 2 depicts a subsystem 299 of the vehicle 100, according to an embodiment of the invention. The subsystem 299 is situated in the tractor unit 110. The subsystem 299 consists of a first control unit 200 which may also be referred to as an ECU.

The first control unit 200 is arranged for communication with an accelerometer 220 via a link 221. Accelerometer 220 is adapted to determining acceleration indications αₛ for the vehicle 100 and to continuously conveying to the first control unit 200 signals which contain information about these acceleration indications αₛ. The accelerometer 220 has a so-called zero level (see also equation 1 above) herein referred to as the zero level α₀.

The first control unit 200 is arranged for communication with a speed sensor 230 via a link 231. The speed sensor 230 is adapted to determining a rotation speed of a wheel of the vehicle. According to a version, the vehicle 100 may be equipped with a number of speed sensors 230 each adapted to determining a prevailing rotation speed of a respective wheel of the vehicle. The speed sensor 230 is adapted to continuously sending to the first control unit 200 signals which contain information about prevailing rotation speeds of a wheel. The first control unit 200 is adapted to determining a vehicle acceleration αᵥ on the basis of said signals conveyed.

The first control unit 200 is arranged for communication with a fuel level sensor 240 via a link 241. The fuel level sensor 240 is adapted to determining a prevailing fuel level in a fuel tank of the vehicle 100. The fuel level sensor 240 is adapted to continuously sending to the first control unit 200 signals which contain information about a prevailing fuel level. The first control unit 200 is adapted to establishing whether refuelling of the vehicle is ongoing or has been completed. To this end the first control unit 200 is adapted to determining the constant α₀ at the time of refuelling of the vehicle 100.

The first control unit 200 is arranged for communication with an engine torque sensor 250 via a link 251. The torque sensor 250 is adapted to determining a prevailing engine torque of the vehicle 100. This may for example be done by continuously determining the amount of diesel fuel injected into combustion chambers of the vehicle's engine. The torque sensor 250 is adapted to continuously sending to the first control unit 200 signals which contain information about a prevailing torque of the vehicle's engine. The first control unit 200 is adapted to determining on the basis of said signals the term Fₜ which appears in equation 2 above.

The first control unit 200 is adapted to continuously calculating both prevailing air resistance Fₐᵢᵣ and rolling resistance Fᵣₒₗₗ (see equation 2 above) by means of a respective stored calculation model, or in some other suitable way.

The first control unit 200 is arranged for communication with a pressure sensor 260 via a link 261. The pressure sensor 260 is adapted to continuously measuring an air pressure P surrounding the vehicle 100. The pressure sensor 260 is adapted to continuously sending to the first control unit 200 signals which contain information about said air pressure surrounding the vehicle. The first control unit 200 is adapted to continuously using said signals conveyed as a basis for determining prevailing air resistance Fₐᵢᵣ by means of the model stored for the purpose.

The first control unit 200 is arranged for communication with a temperature sensor 270 via a link 271. The temperature sensor 270 is adapted to continuously measuring a prevailing ambient temperature T of the vehicle. The temperature sensor 270 is adapted to continuously sending to the first control unit 200 signals which contain information about a prevailing ambient temperature T. The first control unit 200 is adapted to continuously using said signals conveyed as a basis for determining prevailing air resistance Fₐᵢᵣ by means of the model stored for the purpose.

According to a version, the first control unit 200 is adapted to continuously determining prevailing air resistance Fₐᵢᵣ by means of the model stored for the purpose on the basis of said air pressure surrounding the vehicle and/or said prevailing ambient temperature T of the vehicle.

The first control unit 200 is arranged for communication with weight determination means 280. The weight determination means 280 are adapted to determining a weight m of the vehicle 100. This may for example be done by measuring a pressure of at least one air bellows of a suspension system of the vehicle in a conventional way, or in some other suitable way. This makes it possible to determine the vehicle's weight m. The weight determination means 280 are adapted to sending to the first control unit 200 signals which contain information about the vehicle's weight m. The first control unit 200 is adapted to continuously using said signals conveyed as a basis for determining prevailing rolling resistance Fᵣₒₗₗ by means of the model stored for the purpose.

The first control unit 200 is adapted, according to a version, to using the signals received, which contain fuel levels of the vehicle's fuel tank, as a basis for determining a value of the characteristic constant α₀ for the accelerometer 220 in order to make it possible to calibrate the accelerometer, according to the innovative method. The first control unit 200 is thus adapted to establishing whether the vehicle 100 is at a refuelling station, in which case it is supposed that it is on a level running surface.

A second control unit 210 is arranged for communication with the first control unit 200 via a link 201. The second control unit 210 may also be referred to as an ECU. The second control unit 210 may be detachably connected to the first control unit 200. The second control unit 210 may be a control unit external to the vehicle 100. The second control unit 210 may be adapted to performing the innovative method steps according to the invention. The second control unit 210 may be used to cross-load software to the first control unit 200, particularly software for applying the innovative method. The second control unit 210 may alternatively be arranged for communication with the first control unit 200 via an internal network in the vehicle. The second control unit 210 may be adapted to performing substantially similar functions to those of the first control unit 200, e.g. using the signals received, which contain fuel levels of the vehicle's fuel tank, as a basis for determining a value of the characteristic constant α₀ for the accelerometer 220 and thereby making it possible to calibrate the accelerometer 220.

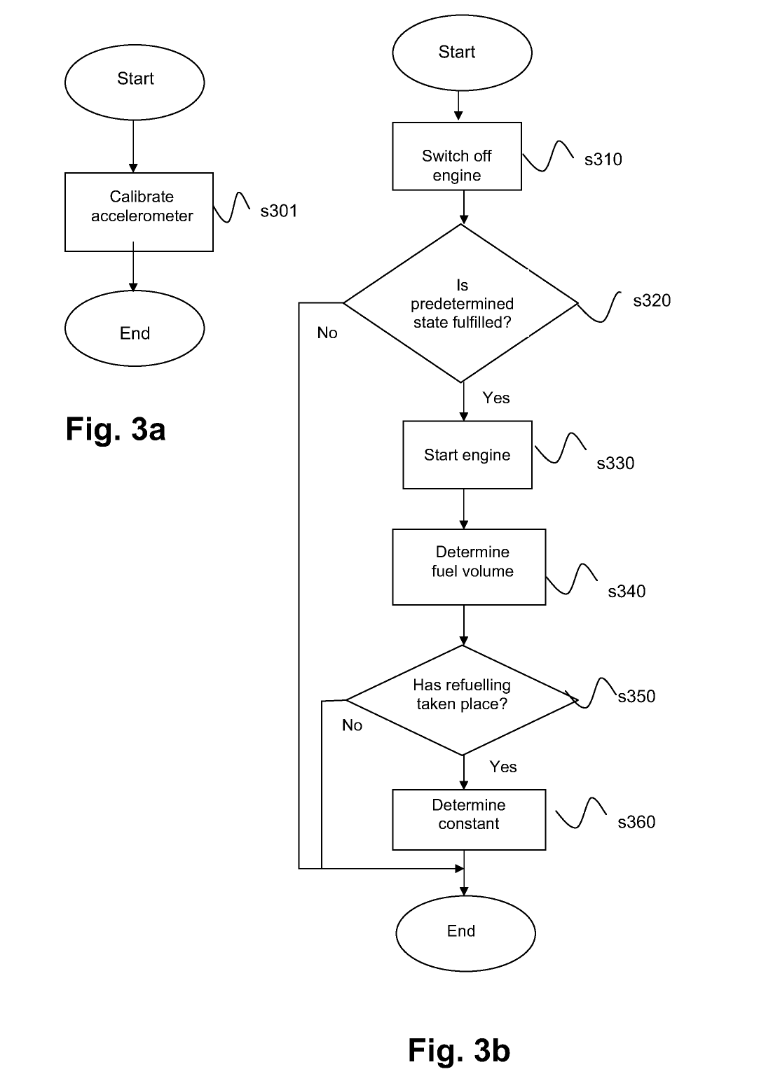

FIG. 3a is a schematic flowchart of a method for calibration of an acceleration sensor in order to determine acceleration indications of a motor vehicle, according to an embodiment of the invention. The method comprises a first step s301 comprising the steps of determining a characteristic constant for said acceleration sensor and determining said constant at the time of refuelling of the vehicle. The method ends after step s301.

FIG. 3b is a schematic flowchart of a method for calibration of an acceleration sensor in order to determine acceleration indications of a motor vehicle, according to an embodiment of the invention.

The method comprises a first step s310 comprising the step of switching off the vehicle's engine. This is typically done by a driver of the vehicle switching off the ignition, e.g. by means of a key or a push-button in the driver's space of the vehicle. Switching off the ignition is registered in the first control unit 200 by means provided for the purpose. At the same time, a Fuellevel1 value which represents a prevailing fuel level in the vehicle's fuel tank is saved in a memory of the first control unit 200. This is done, according to a version, by the fuel level sensor 240 sending information about a fuel level in the vehicle's fuel tank to the first control unit 200, which unit, according to a version, converts said Fuellevel1 to a corresponding Fuelvolume1 and stores in a memory therein a value which represents said Fuelvolume1. Specialists will appreciate that said Fuellevel1 corresponds to said Fuelvolume1. The terms fuel level and fuel volume are herein used synonymously, since they both represent in this case a fuel volume actually prevailing in the vehicle's fuel tank. Step s310 is followed by a step s320.

Method step s320 comprises a step of establishing whether at least one predetermined state is fulfilled. This may also be referred to as establishing whether at least one predetermined state obtains. Step s320 is optional. According to an embodiment, the innovative method may omit step s320. Step s320 serves as a precheck function making it possible to establish whether it is likely that the vehicle is at a refuelling station and is therefore on a supposed level running surface, which is advantageous from the calibration perspective according to the innovative method.

In a first example, one of said predetermined states may be associated with a prevailing speed of the vehicle. If the vehicle's prevailing speed is zero (0) or substantially zero (0), said predetermined state is fulfilled, otherwise not.

In a second example, one of said predetermined states may be associated with a slope α of the vehicle's running surface. A slope a of the vehicle's running surface may be determined in various different ways. If said running surface slope a determined is zero (0), substantially zero (0) or below a predetermined value, e.g. 2 degrees, said predetermined state is fulfilled, otherwise not.

If said at least one predetermined state is fulfilled, a subsequent method step s330 is performed. If said at least one state is not fulfilled, the method ends. According to an example, the method ends if at least one of a number of predetermined states is not fulfilled.

Method step s330 comprises the step of starting the vehicle's engine. This is typically done by a driver of the vehicle switching on the ignition, e.g. by means of a key or a push-button in the driver's space of the vehicle. Switching on the ignition is registered in the first control unit 200 by means provided for the purpose. Step s330 is followed by a step s340.

Method step s340 comprises the step of saving in the memory of the first control unit 200 a Fuellevel2 value which represents a prevailing fuel level in the vehicle's fuel tank. This is done, according to a version, by the fuel level sensor 240 sending information about a fuel level in the vehicle's fuel tank to the first control unit 200, which unit, according to a version, converts said

Fuellevel2 to a corresponding Fuelvolume2 and stores in a memory therein a value which represents said Fuelvolume2. Specialists will appreciate that said Fuellvel2 corresponds in this case to said Fuelvolume2. Step s340 is followed by a step s350.

Method step s350 comprises the step of establishing whether refuelling of the vehicle has taken place. This may be done by comparing the Fuellevel1 and Fuellevel2 determined, or Fuelvolume1 and Fuelvolume2. A difference between Fuellevel2 and Fuellevel1 of more than a predetermined value Th_{fuel} establishes that refuelling has taken place. A difference between Fuellevel2 and Fuellevel1 which is below said predetermined value Th_{fuel} establishes that refuelling has not taken place. The value Th_{fuel} is any appropriate value.

If it is established that the fuelling has taken place, a subsequent method step s360 is performed. If it is established that refuelling has not taken place, the method ends.

It should be noted that the step of establishing whether at least one predetermined state is fulfilled, particularly step s320, may be performed after any step, but before step s360, i.e. after step s330, s340 or s350.

Method step s360 comprises the step of determining the characteristic constant α₀ for the accelerometer 220. According to the innovative method, on the basis of equation 1 above, the magnitude of the value αₛ of the measurement signal from the accelerometer 220 is in this case equal to the characteristic constant α₀ for the accelerometer 220. As the vehicle acceleration αᵥ and the running surface slope a are in this case taken as zero (0), the characteristic constant α₀ can be determined according to an aspect of the invention. The method ends after step s360.

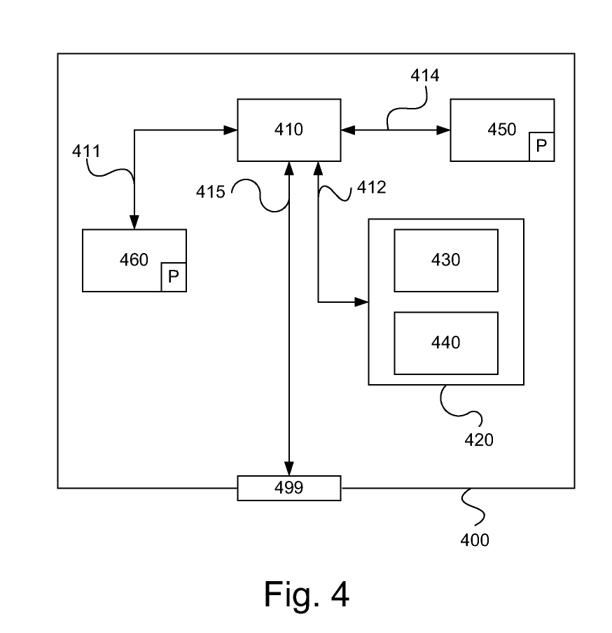

FIG. 4 is a diagram of a version of a device 400. The control units 200 and 210 described with reference to FIG. 2 may in a version comprise the device 400. The device 400 comprises a non-volatile memory 420, a data processing unit 410 and a read/write memory 450. The non-volatile memory 420 has a first memory element 430 in which a computer programme, e.g. an operating system, is stored for controlling the function of the device 200 The device 400 further comprises a bus controller, a serial communication port, I/O means, an ND converter, a time and date input and transfer unit, an event counter and an interruption controller (not depicted). The non-volatile memory 420 has also a second memory element 440.

A proposed computer programme P comprises routines for calibration of an acceleration sensor 220 in order to determine acceleration indications of a motor vehicle 100, according to an aspect of the innovative method. The programme P comprises routines for determining a characteristic constant α₀ for said acceleration sensor at the time of refuelling the vehicle 100. The programme P comprises routines for providing an indication of said refuelling when the amount of fuel supplied exceeds a predetermined value Th_{fuel}, according to an embodiment of the invention. The programme P comprises routines for determining said constant α₀ during refuelling or substantially immediately after completion of refuelling, or for determining said constant α₀ when starting the engine after refuelling or at a predetermined time after the engine has been started after refuelling. The programme P comprises routines for providing said constant α₀ determined for an automatic gearchange system. The programme P comprises routines for determining said slope a on the basis of said constant α₀ determined. The programme P comprises routines for determining said constant α₀ when certain predetermined conditions prevail. According to a version, said acceleration indications are based on the vehicle's acceleration αᵥ and the running surface slope a in the vehicle's longitudinal direction. According to a version, said acceleration sensor's characteristic constant α₀ is referred to the acceleration sensor's acceleration indication. The programme P may be stored in an executable form or in compressed form in a memory 460 and/or in a read/write memory 450.

Where the data processing unit 410 is described as performing a certain function, it means that the data processing unit 410 effects a certain part of the programme which is stored in the memory 460, or a certain part of the programme which is stored in the read/write memory 450.

The data processing device 410 can communicate with a data port 499 via a data bus 415. The non-volatile memory 420 is intended for communication with the data processing unit 410 via a data bus 412. The separate memory 460 is intended to communicate with the data processing unit 410 via a data bus 411. The read/write memory 450 is adapted to communicating with the data processing unit 410 via a data bus 414. The data port 499 may for example have the links 201, 221, 231, 241, 251, 261 and 271 connected to it (see FIG. 2).

When data are received on the data port 499, they are temporarily stored in the second memory element 440. When input data received have been stored temporarily, the data processing unit 410 is prepared to effect code execution as described above. According to a version, signals received on the data port 499 contain information about acceleration indications. These acceleration indications may be measured by the accelerometer 220. According to a version, signals received on the data port 499 contain information about a prevailing speed of one or more of the vehicle's wheels. According to a version, signals received on the data port 499 contain information about a prevailing fuel level, e.g. Fuellevel1 and Fuellevel2, in a fuel tank of the vehicle 100. According to a version, signals received on the data port 499 contain information about a prevailing engine torque of the vehicle 100. According to a version, signals received on the data port 499 contain a prevailing pressure P of air surrounding the vehicle 100. According to a version, signals received on the data port 499 contain a prevailing air pressure in a suspension system of the vehicle 100. According to a version, signals received on the data port 499 contain information about a prevailing ambient temperature T. The signals received on the data port 499 may be used by the device 400 to determine the characteristic constant α₀ for said acceleration sensor at the time of refuelling of the vehicle 100.

The signals received on the data port 499 may be used by the device 400 to calculate and/or determine a running resistance F_{driveres} for the vehicle 100. The signals received on the data port 499 may be used by the device 400 to determine a slope α of the running surface for the vehicle 100. Parts of the methods herein described may be effected by the device 400 by means of the data processing unit 410 which runs the programme stored in the memory 460 or the read/write memory 450. When the device 400 runs the programme, methods herein described are executed.

The foregoing description of the preferred embodiments of the present invention is provided for illustrative and descriptive purposes. It is not intended to be exhaustive nor to restrict the invention to the variants described. Many modifications and variants will obviously suggest themselves to one skilled in the art. The embodiments have been chosen and described in order best to explain the principles of the invention and its practical applications and hence make it possible for specialists to understand the invention for different embodiments and with the various modifications appropriate to the intended use.

1. A method for calibration of an acceleration sensor in order to determine acceleration indications of a motor vehicle, the method comprising the step of determining a characteristic constant (α₀) for the acceleration sensor at a time of refuelling the vehicle and using the constant (α₀) as a zero level for the acceleration sensor.

2. A method according to claim 1, further comprising the step of providing an indication of the refuelling when the amount of fuel supplied to the vehicle during refuelling exceeds a predetermined value.

3. A method according to claim 1, wherein the step of determining the constant (α₀) is performed during refuelling or substantially immediately after completion of the refuelling.

4. A method according to claim 1, wherein the step of determining the constant (α₀) is performed at a time of starting the engine after refuelling or at a predetermined time when the engine has been started after refuelling.

5. A method according to claim 1, further comprising the step of providing the constant (α₀) that has been determined to an automatic gearchange system of the vehicle, for determining when a gearchange of the gearchange system is to be performed.

6. A method according to claim 1, comprising the step of determining the constant (α₀) only when at least one predetermined state of the vehicle obtains.

7. A method according to claim 1, wherein the acceleration indications are based on the vehicle's acceleration (αᵥ) in conjunction with a running surface slope (a) in the vehicle's longitudinal direction of a surface on which the vehicle is located and/or the acceleration sensor's characteristic constant (α₀) is referred to the acceleration sensor's acceleration indication.

8. A device for calibration of an acceleration sensor of a motor vehicle in order to determine acceleration indications of the motor vehicle, wherein the device is configured, and operable for determining a characteristic constant (α₀) for the acceleration sensor, the device comprising:
a determining device configured and operable for determining the constant (α₀) at a time of refuelling the vehicle wherein the constant (α₀) serves as a zero level for the acceleration sensor .

9. A device according to claim 8, further comprising an indicator configured, and operable for providing an indication of the refuelling of the vehicle when the amount of fuel supplied exceeds a predetermined value (Th_{fuel}).

10. A device according to claim 8, wherein the device for determining the constant (α₀) determines during refuelling or substantially immediately after completion of refuelling of the vehicle.

11. A device according to claim 8, wherein the device for determining the constant (α₀) determines at the time of starting the engine of the vehicle after refuelling or at a predetermined time after the engine has been started after refuelling.

12. A device according to claim 8, further comprising the device for determining the constant (α₀), is configured for an automatic gearchange system of the vehicle.

13. A device according to claim 8, wherein the device for determining the constant (α₀) is operable only when at least one predetermined state of the vehicle or of an environment around the vehicle obtains.

14. A device according to claim 8, wherein the acceleration indications are based on the vehicle's acceleration (αᵥ) in conjunction with a running surface slope (a) in the vehicle's longitudinal direction of a surface on which the vehicle is located and/or the acceleration sensor's characteristic constant (α₀) is referred to the acceleration sensor's acceleration indication.

15. A motor vehicle provided with a device according to claim 8.

16. A motor vehicle according to claim 15, which vehicle is any from among a truck, bus or car.

17. A non-transitory computer-readable medium encoded with a computer program (P) for calibration of an acceleration sensor in order to determine acceleration indications of a motor vehicle, which the program (P) containing computer program code for causing an electronic control unit or a computer connected to the electronic control unit to perform steps according to claim 1.

18. A computer program product containing a program code stored on a computer-readable medium for performing method steps according to claim 1 when the computer program is run on an electronic control unit or a computer connected to the electronic control unit.

19. A device according to claim 8, wherein the acceleration indications are based on at least one indication selected from the group consisting of:
the acceleration indications are based on the vehicle's acceleration (αᵥ) in conjunction with a running surface slope (α) in the vehicle's longitudinal direction of a surface on which the vehicle is located and/or the acceleration sensor's characteristic constant (α₀) is referred to the acceleration sensor's acceleration indication, a rotation speed of a wheel of the vehicle, a fuel level sensor for a fuel tank of the vehicle, an engine torque sensor for an engine of the vehicle, an air pressure sensor of air pressure surrounding the vehicle and consequent determination of air resistance on the vehicle, a prevailing air temperature at the vehicle for consequent air resistance on the vehicle, a sensor of air resistance on the vehicle, a sensor for weight of the vehicle for determining road resistance on the vehicle, and a sensor for fuel level in the vehicle fuel tank for determining a value of a characteristic constant for an accelerometer of the vehicle for calibration of the accelerometer,
whereby the selected accelerations indications enable determining if the vehicle is being refuelled and/or is on a level running surface.
